(19) United States
(12) Patent Application Publication
(10) Pub. No.: US 2023/0018196 A1
(43) Pub. Date: Jan. 19, 2023

(54) AUTOMOBILE CARGO COMPARTMENT COVER PLATE

(71) Applicant: SHANGHAI YINTA NETWORK TECHNOLOGY CO., LTD, Shanghai (CN)

(72) Inventor: Shaomin Hu, Shanghai (CN)

(73) Assignee: SHANGHAI YINTA NETWORK TECHNOLOGY CO., LTD, Shanghai (CN)

(21) Appl. No.: 17/782,794

(22) PCT Filed: Apr. 2, 2020
(86) PCT No.: PCT/CN2020/082922

§ 371 Date: Jun. 6, 2022

(30) Foreign Application Priority Data
Jan. 22, 2020 (CN) 202020143828.3

(51) Int. Cl. B60R 5/04

(52) U.S. Cl. CPC B60R 5/044

(57) ABSTRACT

Provided is an automobile cargo compartment cover plate, including a first cover assembly, a second cover assembly, and a third cover assembly, where the first cover assembly includes a first frame and a first cover disposed on the first frame; the second cover assembly includes a second frame and a second cover disposed on the second frame, and the second frame is rotatably connected to the first frame; and the third cover assembly includes a third frame and a third cover disposed on the third frame, and the third frame is rotatably connected to the second frame.

### CROSS-REFERENCE TO RELATED APPLICATION(S

This application is a national stage application filed under 35 U.S.C. 371 based on International Patent Application No. PCT/CN2020/082922, filed Apr. 2, 2020, which claims priority to Chinese Patent Application No. 202020143828.3 filed Jan. 22, 2020, the disclosures of which are incorporated herein by reference in their entirety.

### TECHNICAL FIELD

The present application relates to the technical field of auto parts, for example, to an automobile cargo compartment cover plate.

### BACKGROUND

In order to increase the transportation capacity of automobiles, many people begin to choose vans, and private families in foreign countries prefer pickup trucks. In order to prevent items in a cargo compartment from being spilled, a cover is generally provided on the opening of the cargo compartment.

However, in the related art, covers on the market have problems such as a weak structure, a single function, and an inability to indicate actions.

### SUMMARY

The present application provides an automobile cargo compartment cover plate, which is convenient to use and operate, can indicate an action, and has a relatively strong and firm structure.

The present application adopts solutions below.

An automobile cargo compartment cover plate is provided, including a first cover assembly, a second cover assembly, and a third cover assembly.

The first cover assembly includes a first frame and a first cover disposed on the first frame, and is disposed at an end of an automobile adjacent to a head of the automobile;

The second cover assembly includes a second frame and a second cover disposed on the second frame, where the second frame is rotatably connected to the first frame.

The third cover assembly includes a third frame and a third cover disposed on the third frame, where the third frame is rotatably connected to the second frame and is provided with an indicator strip disposed at an end of the third frame adjacent to a tail of the automobile.

### BRIEF DESCRIPTION OF DRAWINGS

FIG. 1 is a structural view of an automobile cargo compartment cover plate provided by the present application;

FIG. 2 is a sectional view of a first cover assembly provided by the present application;

FIG. 3 is a structural view of a mounting profile and an indicator strip provided by the present application;

FIG. 4 is a structural view of a mounting profile provided by the present application;

FIG. 5 is a structural view of a first flipping profile provided by the present application;

FIG. 6 is a structural view of a first connecting profile provided by the present application; and

FIG. 7 is a partial sectional view of an automobile cargo compartment cover plate provided by the present application.

In the drawings: 1. first cover assembly; 11. first profile; 12. second profile; 13. first flipping profile; 131. connecting block; 132. connecting shaft; 14. first cover;
2. second cover assembly; 21. second flipping profile; 22. third profile; 23. second cover;
3. third cover assembly; 31. third flipping profile; 32. fourth profile; 33. mounting profile; 331. indicator strip; 332. mounting slot; 34. third cover;
4. first connecting profile; 41. receiving slot; 42. arc-shaped groove;
5. second connecting profile; 6. corner connector; 7. right-angle connector; 8. flipping connector

### DETAILED DESCRIPTION

The solutions in the embodiments of the present application will be described clearly and completely in conjunction with the drawings in the embodiments of the present application. Apparently, the embodiments described herein are part, not all, of the embodiments of the present application. Generally, the components described and illustrated in the drawings for the embodiments of the present application may be arranged and designed through various different configurations.

It is to be noted that similar reference numerals and letters indicate similar items in the drawings, and therefore, once a particular item is defined in a drawing, the item does not need to be further defined and explained in subsequent drawings.

In the description of the present application, it is to be noted that orientations or position relations indicated by terms such as “upper”, “lower”, “left”, “right”, “vertical”, “horizontal”, “in”, “out” are orientations or position relations illustrated based on the drawings or orientations or position relations in which a product is generally placed for use. These orientations or position relations are intended only to facilitate the description of the present application and simplify the description and not to indicate or imply that a device or element referred to must have such specific orientations or must be configured or operated in such specific orientations. Thus, these orientations or position relations are not to be construed as limiting the present application. In addition, terms such as “first”, “second” and “third” are only for distinguishing description and not to be construed as indicating or implying relative importance. In the description of the present application, unless otherwise noted, “a plurality of” means two or more.

In the description of the present application, it is to be further noted that, unless otherwise expressly specified and limited, terms “disposed” and “connected” should be construed in a broad sense, for example, may be securely connected, detachably connected or integrated, or may be mechanically connected or electrically connected. For those skilled in the art, specific meanings of the preceding terms in the present application may be understood based on specific situations.

In the present application, unless otherwise expressly specified and limited, when a first feature is described as “on” or “below” a second feature, the first feature and the second feature may be in direct contact or may be in contact via another feature between the two features instead of being in direct contact. Moreover, that the first feature is “on”, “above” or “over” the second feature includes that the first feature is right above or obliquely above the second feature or just indicates that the horizontal level of the first feature is higher than the horizontal level of the second feature. That the first feature is “under”, “below” or “beneath” the second feature includes that the first feature is right below or obliquely below the second feature or just indicates that the horizontal level of the first feature is lower than the horizontal level of the second feature.

The embodiments of the present application are described in detail below, and examples of the embodiments are illustrated in the drawings, where the same or similar reference numerals indicate the same or similar elements or elements having the same or similar functions. The embodiments described below with reference to the drawings are exemplary, intended to explain the present application, and not to be construed as limiting the present application.

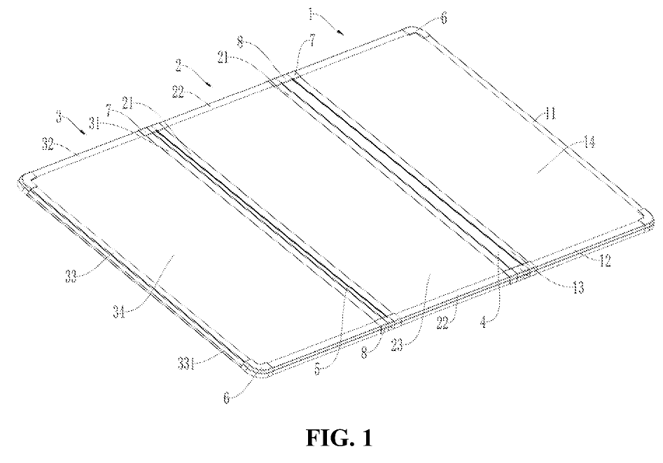

As shown in FIG. 1, this embodiment discloses an automobile cargo compartment cover plate. The automobile cargo compartment cover plate includes a first cover assembly 1, a second cover assembly 2 and a third cover assembly 3. The first cover assembly 1 includes a first frame and a first cover 14 disposed on the first frame. The first cover assembly 1 is located at an end adjacent to a head of the automobile. The second cover assembly 2 includes a second frame and a second cover 23 disposed on the second frame, where the second frame is rotatably connected to the first frame. The third cover assembly 3 includes a third frame and a third cover 34 disposed on the third frame, where the third frame is rotatably connected to the second frame, and an indicator strip 331 is disposed at an end of the third frame adjacent to a tail of the automobile.

The second frame is rotatably connected to the first frame and the third frame, separately, such that the third cover assembly 3 can rotate relative to the second cover assembly 2, and the second cover assembly 2 can rotate relative to the first cover assembly 1. After the automobile cargo compartment cover plate is applied to the automobile, when the goods is loaded or unloaded, the third cover assembly 3 and the second cover assembly 2 are turned upwards, which is convenient to operate; the indicator strip 331 may indicate an action, so that vehicles and pedestrians after the automobile can observe the automobile and the automobile cargo compartment cover plate through the indicator strip 331, and act as indicated; and the automobile cargo compartment cover plate is composed of frames and covers arranged on the frames, and thus has a relatively strong and firm structure. The automobile cargo compartment cover plate has a relatively high structural strength, can be used for placing goods thereon, can be used as a load-bearing board, and has more functions.

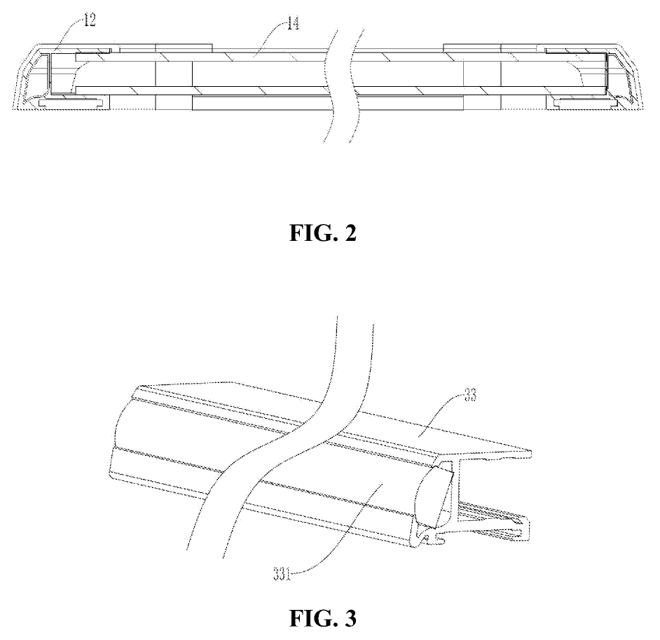

In some embodiments, as shown in FIG. 1 and FIG. 2, the first frame includes a first profile 11, a first flipping profile 13 and two parallel second profiles 12. The second profile 12 has a same structure as the first profile 11, and two ends of the first profile 11 are respectively connected to first ends of the two second profiles 12. In some embodiments, the two ends of the first profile 11 are respectively connected to the first ends of the two second profiles 12 through corner connectors 6, where two right-angle plugs of the corner connector 6 are respectively inserted into an end of the first profile 11 and an end of the second profile 12. Two ends of the first flipping profile 13 are respectively connected to second ends of the two second profiles 12. In some embodiments, the two ends of the first flipping profile 13 are respectively connected to the second ends of the two second profiles 12 through right-angle connectors 7, and the two right-angle plugs of the corner connector 6 are respectively inserted into the end of the first profile 11 and the end of the second profile 12. Four sides of the first cover 14 are respectively fixed to an inner side of the first profile 11, an inner side of the first flipping profile 13 and an inner sides of the two second profiles 12. In some embodiments, grooves are provided on all the inner sides of the first profile 11, the second profile 12, and the first flipping profile 13. Two first covers 14 are arranged at intervals; four sides of each of the two first covers 14 are respectively fixed to a respective inner wall of the grooves of the first profile 11, a respective inner wall of the groove of each of the two second profiles 12, and a respective inner wall of the groove of the first flipping profile 13, where the fixing method may be bonding, riveting, screwing, and so on.

With continued reference to FIG. 1, the second frame includes two parallel second flipping profiles 21 and two parallel third profiles 22. The third profile 22 has the same structure as the first profile 11, and the second flipping profile 21 has the same structure as the first flipping profile 13. Two ends of one of the two second flipping profiles 21 adjacent to the first cover assembly 1 are respectively connected to first ends of the two third profiles 22. In some embodiments, the two ends of another of the two second flipping profiles 21 are respectively connected to the first ends of the two third profiles 22 through the right-angle connectors 7, where two right-angle plugs of the right-angle connector 7 are respectively inserted into an end of the second flipping profile 21 and one end of the two third profile 22. Two ends of another of the two second flipping profiles 21 (that is, the second flipping profile 21 adjacent to the third cover assembly 3) are respectively connected to second ends of the two third profiles 22. In some embodiments, the two ends of the second flipping profile 21 are respectively connected to the second ends of the two third profiles 22 through the right-angle connectors 7, where two right-angle plugs of the right-angle connector 7 are respectively inserted into an end of the second flipping profile 21 and an end of the third profile 22. Four sides of the second cover 23 are respectively fixed to inner sides of the two second flipping profiles 21 and the two third profiles 22. In some embodiments, grooves are provided on both the inner sides of the third profile 22 and the second flipping profile 21. Two second covers 23 are arranged at intervals; four sides of each of the two second covers 23 are respectively fixed to a respective inner wall of the grooves of each of the two third profiles 22 and a respective inner wall of the groove of each of the two second flipping profiles 21, where the fixing method may be bonding, riveting, screwing, and so on.

The third frame includes a third flipping profile 31, a mounting profile 33, and two parallel fourth profiles 32. The third flipping profile 31 has the same structure as the first flipping profile 13, and the fourth profile 32 has the same structure as the first profile 11. Two ends of the mounting profile 33 are respectively connected to second ends of the two fourth profiles 32. In some embodiments, the two ends of the mounting profile 33 are respectively connected to the second ends of the two fourth profiles 32 through the corner connectors 6; where two right-angle plugs of the corner connector 6 are respectively inserted into an end of the fourth profile 32 and an end of the mounting profile 33. Two ends of the third flipping profile 31 are respectively connected to first ends of the two fourth profiles 32. In some embodiments, the two ends of the third flipping profile 31 are respectively connected to the first ends of the two fourth profiles 32 through the right-angle connectors 7, where two right-angle plugs of the right-angle connector 7 are respectively inserted into an end of the third flipping profile 31 and an end of the fourth profile 32. Four sides of the third cover 34 are respectively fixed to an inner side of the third flipping profile 31, an inner side of the mounting profile 33 and inner sides of the two fourth profiles 32. In some embodiments, grooves are provided on all the inner sides of the fourth profile 32, the third flipping profile 31, and the mounting profile 33. Two third covers 34 are arranged at intervals; four sides of each of the two third covers 34 are respectively fixed to a respective inner wall of the groove of the third flipping profile 31, a respective inner wall of the groove of each of the two fourth profiles 32 and a respective inner wall of the groove of each of the mounting profile 33, where the fixing method may be bonding, riveting, screwing, and so on.

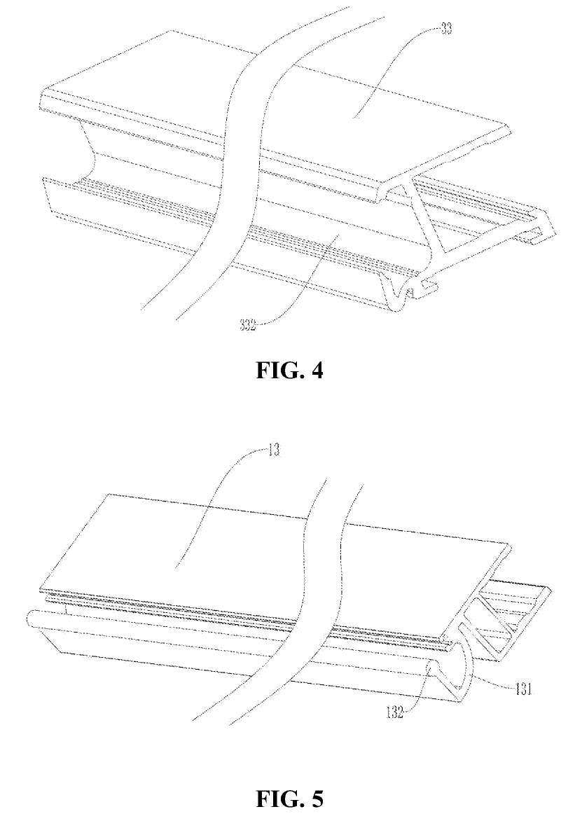

Referring to FIG. 3 and FIG. 4, an outer side of the mounting profile 33 is provided with a mounting slot 332 along a length direction. The indicator strip 331 is inserted into the mounting slot 332 from one end of the mounting profile 33, and an opening of the mounting slot 332 has a baffle edge extending inwards, where the baffle edge is used for baffling the indicator strip 331, so as to prevent the indicator strip 331 from leaving off the mounting slot 332. Optionally, the indicator strip 331 in the embodiment is a light bar, and a cable of the light bar is connected to a spare light bar interface of the automobile.

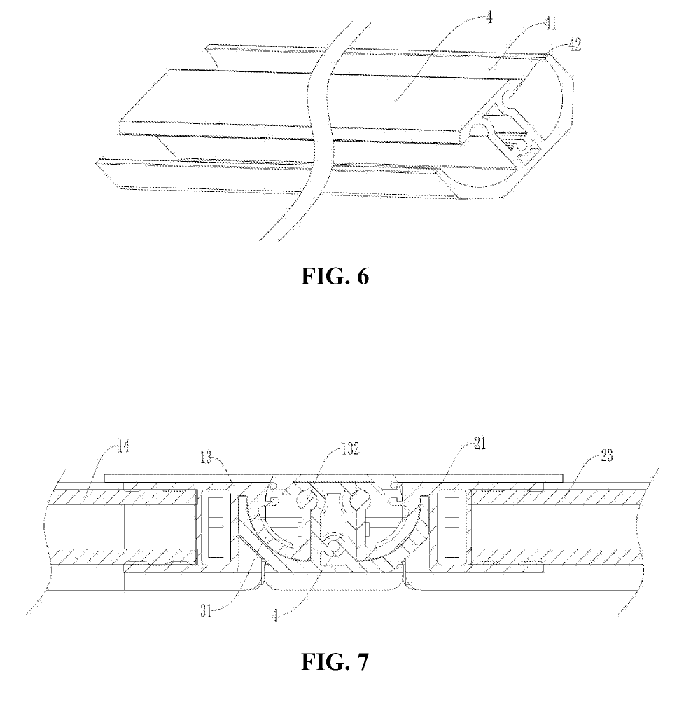

Optionally, as shown in FIG. 1 and FIGS. 5 to 7, the automobile cargo compartment cover plate further includes a first connecting profile 4 and a second connecting profile 5. A receiving slots 41 with upward openings is provided on a left side and a right side of the first connecting profile 4 along the length direction of the first connecting profile 4, respectively. The receiving slot 41 includes an arc-shaped wall and a vertical wall, where an arc measure of the arc-shaped wall is 90°, the vertical wall is located on an inner side of the receiving slot 41, the top of the vertical wall is provided with an arc-shaped groove 42 whose arc measure is 270°, and the top of the vertical wall is provided with a baffle strip on a side facing towards the receiving slot 41.

A connecting block 131 matching the receiving slot 41 is provided on an outer side of the first flipping profile 13. The connecting block 131 includes an arc-shaped surface and a vertical surface. The vertical surface is located on the outer side of the connecting block 131, and a top of the vertical surface of the connecting block is provided with a connecting shaft 132. When the connecting block 131 is inserted into the receiving slot 41 from one end of the receiving slot 41, the connecting shaft 132 is inserted into the arc-shaped groove 42. The arc-shaped groove 42 enables the connecting shaft 132 to be engaged in the arc-shaped groove 42 to prevent it from falling off when rotated.

The second flipping profile 21 has the same structure as the first flipping profile 13. The first connecting profile 4 is provided between the first cover assembly 1 and the second cover assembly 2, and the connecting block 131 of the first flipping profile 13 and the connecting block 131 of one of the two second flipping profiles 21 adjacent to the first cover assembly 1 are respectively arranged within two receiving slots 41 of the first connecting profile 4. The second connecting profile 5 has a same structure as the first connecting profile 4, the second connecting profile 5 is provided between the second cover assembly 2 and the third cover assembly 3, and the connecting block 131 of the second flipping profile 21 and the connecting block 131 of the third flipping profile 31 are respectively arranged within two receiving slots 41 of the second connecting profile 5.

Each of two ends of the first connecting profile 4 and each of two ends of the second connecting profile 5 are respectively plugged with a flipping connector 8, one of the right-angle connectors 7 on the first flipping profile 13 and a respective one of the right-angle connectors 7 on the one of the two second flipping profiles 21 adjacent to the first cover assembly 1 are all rotatably connected to a respective flipping connector 8 on the first connecting profile 4, and one of the right-angle connectors 7 on the third flipping profile 31 and a respective one of the right-angle connectors 7 on the one of the two second flipping profiles 21 adjacent to the third cover assembly 3 are all rotatably connected to a respective flipping connectors 8 on the second connecting profile 5. In this way, it can be ensured that the third cover assembly 3 can rotate relative to the second cover assembly 2, and the second cover assembly 2 can rotate relative to the first cover assembly 1. Optionally, the corner connector 6, the right-angle connector 7, and the flipping connector 8 in the embodiment are all plastic.

In the present application, the second frame is rotatably connected to the first frame and the third frame, separately, so that the third cover assembly can rotate relative to the second cover assembly, and the second cover assembly can rotate relative to the first cover assembly; after the automobile cargo compartment cover plate is applied to the automobile, when the goods is loaded or unloaded, the third cover assembly and the second cover assembly are turned upwards, which is convenient to operate; the indicator strip may indicate an action, so that vehicles and pedestrians after the automobile can observe the automobile and the automobile cargo compartment cover plate through the indicator strip, and act as indicated; and the first cover assembly, the second cover assembly or the third cover assembly is composed of a frame and a cover disposed on the frame, and thus has a relatively strong and firm structure. The automobile cargo compartment cover plate has a relatively high structural strength, can be used for placing goods thereon, can be used as a load-bearing board, and has more functions.

1. An automobile cargo compartment cover plate, comprising:
a first cover assembly wherein the first cover assembly comprises a first frame and a first cover disposed on the first frame, and is disposed at an end of an automobile adjacent to a head of the automobile;
a second cover assembly, wherein the second cover assembly comprise a second frame and a second cover disposed on the second frame, and the second frame is rotatably connected to the first frame; and
a third cover assembly, wherein the third cover assembly comprises a third frame and a third cover disposed on the third frame, and the third frame is rotatably connected to the second frame and is provided with an indicator strip disposed at an end of the third frame adjacent to a tail of the automobile.

2. The automobile cargo compartment cover plate according to claim 1, wherein the first frame comprises a first profile, a first flipping profile and two parallel second profiles, wherein two ends of the first profile are respectively connected to first ends of the two parallel second profiles, two ends of the first flipping profile are respectively connected to second ends of the two parallel second profiles, and four sides of the first cover are respectively fixed to an inner side of the first profile, an inner side of the first flipping profile and inner sides of the two parallel second profiles.

3. The automobile cargo compartment cover plate according to claim 2, wherein the second frame comprises two parallel second flipping profiles and two parallel third profiles, wherein two ends of one of the two parallel second flipping profiles adjacent to the first cover assembly are respectively connected to first ends of the two parallel third profiles, two ends of another of the two parallel second flipping profiles are respectively connected to second ends of the two parallel third profiles, and four sides of the second cover are respectively fixed to inner sides of the two parallel second flipping profiles and inner sides of the two parallel third profiles.

4. The automobile cargo compartment cover plate according to claim 3, wherein the third frame comprises a third flipping profile, a mounting profile, and two parallel fourth profiles, wherein two ends of the third flipping profile are respectively connected to first ends of the two parallel fourth profiles, two ends of the mounting profile are respectively connected to second ends of the two parallel fourth profiles, the indicator strip is inserted into a mounting slot on an outer side of the mounting profile, and four sides of the third cover are respectively fixed to an inner side of the third flipping profile, an inner side of the mounting profile, and inner sides of the two parallel fourth profiles.

5. The automobile cargo compartment cover plate according to claim 4, wherein the indicator strip is a light bar, and an opening of the mounting slot has a baffle edge extending inwards, wherein the baffle edge is used for baffling the indicator strip.

6. The automobile cargo compartment cover plate according to claim 4, further comprising a first connecting profile, wherein a receiving slot with an upward opening is provided on a left side and a right side of the first connecting profile along a length direction of the first connecting profile, respectively, the receiving slot comprises an arc-shaped wall and a vertical wall, the vertical wall is located on an inner side of the receiving slot, and a top of the vertical wall is provided with an arc-shaped groove;
wherein a connecting block matching the receiving slot is provided on an outer side of the first flipping profile, wherein the connecting block (131) comprises an arc-shaped surface and a vertical surface, wherein the vertical surface is located on the outer side of the connecting block, and a top of the vertical surface of the connecting block is provided with a connecting shaft rotatably disposed within the arc-shaped groove; and
wherein each of the two parallel second flipping profiles has a same structure as the first flipping profile, the first connecting profile is provided between the first cover assembly and the second cover assembly, the connecting block of the first flipping profile (13) and a connecting block (131) of one of the two parallel second flipping profiles adjacent to the first cover assembly are respectively arranged within two receiving slots of the first connecting profile.

7. The automobile cargo compartment cover plate according to claim 6, further comprising a second connecting profile, wherein the second connecting profile has a same structure as the first connecting profile, and the third flipping profile has a same structure as the first flipping profile; and
wherein the second connecting profile is provided between the second cover assembly and the third cover assembly, and a connecting block of one of the two parallel second flipping profiles adjacent to the third cover assembly and a connecting block of the third flipping profile are respectively arranged within two receiving slots of the second connecting profile.

8. The automobile cargo compartment cover plate according to claim 6, wherein a groove is provided on an inner side of each of the first profile , the two parallel second profiles, the two parallel third profiles, the two parallel fourth profiles, the first flipping profile, the two parallel second flipping profiles, the third flipping profile, and the mounting profile , and wherein two first covers, two second covers, and two third covers are provided;
wherein four sides of each of the two first covers are respectively fixed to a respective inner wall of the groove of the first profile, a respective inner wall of the groove of each of the two parallel second profiles, and a respective inner wall of the groove of the first flipping profile; four sides of each of the two second covers are respectively fixed to a respective inner wall of the groove of each of the two parallel third profiles and a respective inner wall of the groove of each of the two parallel second flipping profiles; and four sides of each of the two third covers are respectively fixed to a respective inner wall of the groove of the third flipping profile, a respective inner wall of the groove of each of the two parallel fourth profiles, and a respective inner wall of the groove of the mounting profile.

9. The automobile cargo compartment cover plate according to claim 4, wherein the two ends of the first profile are respectively connected to the first ends of the two parallel second profiles through corner connectors , and the two ends of the mounting profile are respectively connected to the second ends of the two parallel fourth profiles through the corner connectors .

10. The automobile cargo compartment cover plate according to claim 7, wherein the two ends of the first flipping profile are respectively connected to the second ends of the two parallel second profiles through right-angle connectors, the two ends of the one of the two parallel second flipping profiles adjacent to the first cover assembly are respectively connected to the first ends of the two parallel third profiles through the right-angle connectors, the two ends of the another of the two parallel second flipping profiles are respectively connected to the second ends of the two parallel third profiles through the right-angle connectors, and the two ends of the third flipping profile are respectively connected to the first ends of the two parallel fourth profiles through the right-angle connectors; and
wherein each of two ends of the first connecting profile and each of two ends of the second connecting profile are respectively plugged with a flipping connector , wherein one of the right-angle connectors on the first flipping profile and a respective one of the right-angle connectors on the one of the two parallel second flipping profiles adjacent to the first cover assembly (1) are all rotatably connected to a respective flipping connector on the first connecting profile, and one of the right-angle connectors on the third flipping profile and a respective one of the right-angle connectors on the one of the two parallel second flipping profiles adjacent to the third cover assembly are all rotatably connected to a respective flipping connector on the second connecting profile.
